(19) United States
(12) Patent Application Publication
(10) Pub. No.: US 2010/0109936 A1
(43) Pub. Date: May 6, 2010

(54) AIRCRAFT ANTI-COLLISION SYSTEM AND METHOD

(75) Inventor: Yona Levy, Beer Yaacov (IL)

Correspondence Address: BROWDY AND NEIMARK, P.L.L.C.;624 NINTH STREET, NW, SUITE 300, WASHINGTON, DC, 20001-5303, US

(73) Assignee: Israel Aerospace Industries Ltd., Lod (IL)

(21) Appl. No.: 11/994,290

(22) PCT Filed: Nov. 28, 2007
(86) PCT No.: PCT/IL2007/001469

§ 371 Date: Dec. 28, 2007

(30) Foreign Application Priority Data
Nov. 28, 2006 (IL) 179678

(51) Int. Cl. G08G 5/06; G01S 13/93; G08G 5/04

(52) U.S. Cl. 342/30; 340/961

(57) ABSTRACT

A system and method for avoiding aircraft collisions wherein a ground based monitoring station serves as one port of a wireless LAN operating according to a wireless communications protocol compatible with the IEEE 802.16e standard and derivatives thereof. A mobile unit associated produces respective position-dependent signals of an authorized object that are conveyed to the ground based monitoring station and to respective mobile units associated with other mobile units via the wireless LAN. A collision prediction unit is responsive to the position-dependent signals and to static position data of the airport infrastructure for predicting collisions between mobile objects or between a mobile object and the infrastructure. A warning unit coupled to the collision prediction unit and responsive to a predicted collision involving one or more mobile objects conveys a respective warning to the one or more mobile objects for allowing evasive action.

### FIELD OF THE INVENTION

This invention relates to aircraft anti-collision systems particularly at or in the vicinity of airports.

### BACKGROUND OF THE INVENTION

Air traffic at large airports is generally managed and pilots are apprised of danger by an air traffic controller. In the absence of such an air traffic controller, it is also known for pilots to relay vital information to each other, regarding their locations, intentions and so on so as to increase pilot awareness and, hence, air traffic safety. A number of other systems have been proposed to enhance air traffic safety. These systems include electronic surveillance devices, the primary purpose of which is to alert pilots about the presence, and sometimes location, of aircraft and inclement weather conditions that pose an immediate threat to the pilot and passengers on board.

Systems have also been proposed in which a visual display is used to alert pilots when another aircraft is close in proximity. For example, one pilot advisory system tracks the location and associated trajectories of aircraft in the vicinity of a protected aircraft. When the monitored air traffic data indicates that two aircraft are getting too close to each other, the computer generates a climb or descend recommendation and displays the information on a screen for the pilot. Contrasting colors and descriptive symbols on the display aid in conveying the appropriate message to the pilot.

There is a wealth of literature relating to aircraft anti-collision systems, some of which relates also to airport anti-collision systems.

US2002109612 discloses a method and apparatus for automatically providing advisories to pilots in a monitored airspace. An airspace model, made up of a multitude of constantly updated records, is used to keep track of important flight information and weather conditions. A monitoring CPU, accessing the airspace model, creates advisory messages based upon hazard criteria, guidelines, airport procedures and other relevant air traffic data.

US2002133294 discloses a method and apparatus to provide coordinated evasive maneuver commands to aircraft to avoid collisions. Aircraft location is determined using GPS and the apparatus includes control logic to calculate evasive maneuvers, display aircraft tracking information, coordinate the evasive maneuver with the intruding aircraft, and give a synthetic voice warning and command to the pilots.

U.S. Pat. No. 4,706,198 discloses a computerized system for automated aircraft traffic control. The system includes a master control unit having stored information identifying and characterizing all aircraft flying in the controlled airspace. A plurality of regional control units are linked for communication with the master control unit. Airport terminal and en route control stations in each region are linked to the regional control unit for that region. Each aircraft flying in the region is equipped with a data-link console for communication with the regional control unit. The aircraft data-link provides identification and flight condition data to the regional control unit, and the regional control unit provides weather data and guidance signals to the aircraft.

U.S. Pat. No. 5,153,836 discloses a craft tracking and collision avoidance system that allows the positions of a plurality of craft, either on land, sea, or air, or space, to be monitored. Each craft determines and transmit its own position on a regular basis for reception by other craft so as to allow determination of the proximity and identity of other craft, and if the craft are on a collision course. The position of all the craft within a predetermined range of a craft may be represented on a display in order to give the craft operator a visual indication of traffic surrounding his craft.

The above-mentioned references are representative of known anti-collision systems some of which are specifically intended for use in airports and the contents of all of which are incorporated herein by reference.

U.S. Pat. No. 6,246,320 (Monroe) issued Jun. 12, 2001 discloses a surveillance system supporting communication of monitored data and/or commands or operational data between the ground or base station and transport, between the transport and ground or terminal support vehicles and/or equipment, between the transport and various monitoring stations or systems, between transports, between the ground station and the support vehicles, between the monitoring station and support vehicles and between the monitoring stations or systems and the support vehicles. This permits the ground station to monitor and/or determine the identity, location, and heading of any vehicle in its range for tracking and collision avoidance. Similar information may be transmitted and received between any combination of transports, monitoring stations, personnel, mobile units and support vehicles. The full contents of U.S. Pat. No. 6,246,320 are incorporated herein by reference.

U.S. Pat. No. 6,246,320 also permits complete monitoring of on ground movement of airport traffic, and allows the monitoring of other commercial transport in the area to assure that the various transports do not interfere with one another. This provides collision avoidance, and can be utilized both on the ground and in the air or in route via water or land. It is further noted that current airborne collision avoidance is accomplished by use of a radar transponder. Aircraft position is located by radar “echo” response and altitude by a “reporting altimeter” reading being returned to the radar system encoded in the transporter return. Use of a satellite based LAN or WAN provides an “intranet in the sky”, providing much more accurate GPS position, altitude, heading, speed and other navigational information to the FAA and other operators and computer tracking and monitoring stations, thus enhancing collision avoidance information.

The potential for airport and runway collisions increases as a function of the frequency of landing and takeoff. In other words, the busier the airport, the greater is the likelihood of runway intrusions. It is clearly not enough merely to predict potential collisions: it is essential that this be done in sufficient time to allow evasive action. It is clear that the use of radio echo response and satellite based LAN or WAN to determine the instantaneous positions of moving objects may be applicable for objects that are remote from each other or are airborne and therefore out of range of the ground-based wireless LAN. However, there is an increasing need to prevent collisions on the runway itself. Some of these, such as a taxiing aircraft that collides with a service vehicle, may be handled by the system described in U.S. Pat. No. 6,246,320. But there are many other sources of collision that appear not to be handled by U.S. Pat. No. 6,246,320. For example, no provision appears to be made for a taxiing aircraft that collides with the airport terminal or another part of the airport infrastructure. Likewise, an aircraft that is taking off or landing at high speed may be too fast for the GPS system employed by U.S. Pat. No. 6,246,320 to respond in sufficient time to allow evasive action to be taken.

The use of radio echo response and satellite based LAN or WAN to determine the instantaneous positions of moving objects is consistent with the emphasis made in U.S. Pat. No. 6,246,320 that what is proposed therein is a surveillance system intended to monitor unauthorized security breaches. The fact that the system described by U.S. Pat. No. 6,246,320 is described as being capable of limited collision avoidance appears to be incidental. In any event, the system disclosed in U.S. Pat. No. 6,246,320 is not capable of permitting collision avoidance in crowded airport environments, for a number of reasons. First, the large high and increasing volume number of takeoffs and landings may be expected to give rise to a statistical increase in the number of collisions. At the same time, the increased volume adds to the pressure on pilots, which may be expected to increase still further the risk of collision.

It should further be noted that surveillance systems typically have one or more display devices that are located in a central office where one or more security officers are able to monitor activity in the area being surveyed. Frequently, such display devices have split screens each displaying a different area imaged by a respective camera, so that the security officer is able to monitor different areas simultaneously. Centralized processing and display of data lends itself also to anti-collision systems only in cases where the speed of moving objects is sufficiently slow, or where potential collisions can be detected when the distance between the colliding vehicles is sufficiently large that even at high speeds there is sufficient time for remedial action to be taken. These conditions do not obtain in crowded airports with frequent takeoffs and landings on a restricted number of runways. In such cases, conventional centralized processing and display of data does not allow an air traffic controller sufficient time to process the information, determine that aircraft are on a collision course and advise the pilots in sufficient time to permit them to take remedial action. There have been proposals to overcome this limitation by the use of automated controllers based on situation awareness managers that assists the human air traffic controller and, in response to a potential collision provide automated vocal warnings to the pilots at risk. Such an approach is described in WO 2007/052248 and entitled “Vocal alert unit having automatic situation awareness” assigned to ELTA Systems Ltd. and whose contents are wholly incorporated herein by reference.

As noted above, an aircraft that is taking off or landing at high speed may be too fast to allow know systems to respond in sufficient time to allow evasive action to be taken. Much effort has been made in recent years to provide ever faster wireless communications protocols and some of these have been fined tuned for use with satellite communication. For example, WiMAX (Worldwide Interoperability for Microwave Access), based on the IEEE 802.16 standard and its derivatives, provides high-speed mobile data and telecommunications services of at least 1 Gbit/sec. The currently most recent version is IEEE 802.16e and uses orthogonal frequency-division multiplexing (OFDM).

Some 802.16e and/or WiMAX communication systems, such as S-WiMAX systems, may include communicating with one or more satellites. Although downlink communication from a satellite to mobile units or user terminals spread over a wide area may be implemented with one satellite, it may be impractical to receive uplink transmission from all the users via only a single satellite.

When there is one satellite, ranging and setting appropriate time delays for each of the mobile units can reduce synchronization problems. However, it is often desirable to communicate with more than one satellite. When two or more satellites are employed that are spatially separated by very large distances, it is not possible to synchronize in the time domain to both satellites simultaneously. It is usual to synchronize mobile units in the time domain to one satellite, referred to as the “master satellite”, which receives multiple signals in the frequency domain from different mobile units and performs FFT (Fast Fourier Transform) to separate the signals. This is possible providing that all signals start at substantially the same time. However the same temporal alignment does not hold when the uplink signals arrive at the second satellite owing to the spatial separation between the two satellites that gives rise to time delays between signals arriving from the mobile units to the different satellites. This is resolved by the second satellite performing a different FFT to resolves the signals.

The problem becomes challenging owing to the large relative delay between users arising from large geographical variance. As is known, in order to prevent data collisions between successive packets, a guard-interval is set that effectively increases the minimal transmission time of each data packet. If the guard-interval is too large, this prevents collisions but reduces the average transmission rate. So in order to increase the transmission rate, the guard-interval should be reduced as much as possible, but without introducing too high a risk of data collision. However, in the case where the relative delay exceeds the guard-interval, which may be approximately 50 microseconds, inter-symbol interference will occur.

This imposes practical limitations when WiMAX is used for an aircraft anti-collision system since particularly during landing and takeoff when aircraft are traveling at high speeds, there is a higher risk of data collisions and vital data can therefore be lost during the crucial fractions of a second when warning and evasive action would still be possible if data arrived intact.

However, even when aircraft are confined to the relative proximity of the airport and are thus able to communicate without the need for satellite links, their high speeds give rise to Doppler frequency shifts. In accordance with the Doppler Effect, when a mobile transmitter moves away from a receiver such as a base station, the frequency of the received signal is lower than the transmitted signal; and when the mobile transmitter moves toward the receiver, the frequency is higher. As a result, a frequency spread is caused in the signal spectrum. Problems of Doppler shift are particularly acute when high speed aircraft take off and come in to land. Specifically, the high velocities associated with an aircraft anti-collision system imply Doppler frequency shifts exceeding the customary values of mobile WiMAX (usually up to 400 Hz), which means that the standard WiMAX frequency synchronization mechanism is unsuitable. This clearly militates against the use of WiMAX in an anti-collision system for aircraft use.

Compensation for Doppler shift in mobile communication systems is known. For example, US 2007/197165 (Klotsche et al.) describes a Doppler compensation method for radio transmission between a mobile body and base station. The direction of motion of the mobile body with respect to the active base is determined after which a constant Doppler compensation is applied.

Usually frequency offsets results from clock mismatch (the clock of the base station vs. that of the mobile platform) and Doppler shifts induced by motion. In WiMAX, synchronization is a task performed by the mobile platform. Synchronization is usually obtained in the following stages.
a) The mobile platform receives the downlink subframe and estimates the start-of-frame exploiting the special characteristics of the preamble symbol (time synchronization).
b) The mobile platform performs coarse frequency synchronization (up to a fraction of the subcarrier spacing).
c) The mobile platform tracks frequency changes each frame (fine frequency synchronization).
d) The mobile platform transmits with the frequency compensation obtained in stages b) and c).

It should be noted that in the case of slowly varying clock mismatch, the mismatch may be compensated for with high accuracy. However, in the case of Doppler, the uplink signal propagating from the mobile platform to the base station experiences another Doppler shift (similar to the downlink signal) which is not compensated for by the mobile platform. Thus, the uplink signal arrives at the base station with a Doppler shift having magnitude that is bounded by:

$$\frac{v \cdot {f}_{c}}{c} \qquad ( 1 )$$

where: f_{c} is the carrier frequency [Hz];

v is the speed of the mobile platform [m/sec]; and

c is the speed of light [m/sec].

It is also to be noted that in mobile WiMAX, the uplink frequency offset is usually smaller than 5% of the carrier spacing and allows a QPSK (quadrature phase-shift keying) rate half decoding (which is the customary modulation and coding in high mobility). However in the case of significantly larger velocities (or significantly larger carrier frequencies), the Doppler shift causes larger inter-carrier-interference which may considerably degrade the system performance.

Further systems currently being employed to assist in detecting and preventing collisions include the following:

Airport Surface Detection Equipment—Model 3 (ASDE-3):

This radar helps air traffic controllers manage the orderly movement of aircraft and ground vehicles on the airport surface, especially during low or no visibility conditions, such as rain, fog and night operations. The ASDE-3 display shows aircraft and vehicles as they operate on the airport ground. However, the radar does not tag aircraft—in other words, each blip on the screen does not have an attached information tag that identifies the aircraft, nor does it contain any conflict prediction or alerting logic. It is strictly a surveillance system that effectively supplements the controller's vision.

Airport Movement Area Safety System (AMASS):

AMASS builds on the ASDE-3 radar information by adding conflict detection and warning logic that visually and aurally warns air traffic controllers that a runway incursion is about to, or has, occurred. The system works by processing surveillance data from the ASDE-3, the airport surveillance radar, and the terminal automation system. It then determines conflicts based on the position, velocity and acceleration of airborne aircraft, as well as ground-based aircraft and vehicles.

Runway Status Lights—“Transtech” (RWSL):

RWSL is a system of lights automatically-controlled through the use of surface radar data. These lights are designed to improve situational awareness of the runways' status by informing pilots and ground vehicle operators when a runway is unsafe to enter/cross or to begin take-off. When surveillance data from ASDE-3 and other airport radar indicate that an aircraft with a trajectory aligned with a runway is landing or taking off, or otherwise approaching an intersection with a taxiway, the red lights at that intersection are automatically illuminated.

In-Cockpit Moving Map Displays:

In-cockpit moving map displays are a promising new technology to improve pilots' situational awareness on the airport surface. Currently, pilots use paper maps to navigate the airport surface, and can become disoriented, leading to runway incursions. In fact, loss of situational awareness is thought to be the most common cause of pilot deviations, which are themselves the most common cause of runway incursions.

With an electronic moving map display, the pilot can see exactly where he is on the airport surface at all times. The electronic moving map depicts the cleared taxi route, as well as real-time information about the aircraft's own position, other airport traffic, and hold short positions. Each runway and taxiway is identified by name on the moving map.

Airport Surface Detection Equipment—Model X (ASDE-X):

The next generation of the ASDE-3 is known as the ASDE-X. The FAA awarded the ASDE-X contract to the Sensis Corporation in November 2000. Unlike the ASDE-3/AMASS combination, which receives data from a single source (surface movement radar), the ASDE-X receives and combines data from three sources:
(1) surface movement radar.
(2) multiple fixed transmitters and receivers situated around the airport property that will send and receive signals from aircraft transponders (known as transponder multilateration).
(3) automatic dependent surveillance broadcast (ADS-B), which uses the Global Positioning System to allow each aircraft to continuously broadcast its position.

FIG. 1 is graphical representation illustrating the extent of airport collisions in the USA during the years 2005-2006. It is seen that there has been a significant increase in airport collisions during the twelve months preceding filing of this application. Moreover, FIG. 1 relates not to expected collisions but to actual collisions and yet only in the USA. It hardly needs adding that the problem of airport collisions or runway incursions is not restricted to any one country. Worldwide the ever-increasing volume of air traffic and the consequent constraints this makes on airport infrastructure has turned runway incursions into a global problem of epidemic proportions.

In March 2006, planes were twice in one week forced to abort takeoffs at O'Hare International Airport to avoid colliding with other aircraft. In one close call, two airliners that were mistakenly instructed to take off at the same time on crisscrossing runways came within 100 feet of each other before the pilots were alerted and stopped their planes near the runway intersection, officials said. According to the FF, incidents of such severity occur, on average, less than one time for every million takeoffs and landings. The FAA further declared that both incidents looked to be air-traffic controller errors. It is clear that whatever the pressure may be on an individual pilot who is responsible only for the safe takeoff and landing of his aircraft, the pressure on the air-traffic controller is exponentially higher since each air-traffic controller is responsible for the safe takeoff and landing of many aircraft simultaneously.

The increasing growth of airport incursions in European airports is well documented. It is noteworthy that from 1999-2004 every week more than one runway incursion is reported in Europe. Clearly these statistics are indicative of the failure of current systems to provide an airport anti-collision system that responds in sufficient to allow corrective action to be taken in the increasingly dense environment of congested airports.

### SUMMARY OF THE INVENTION

It is therefore an object of the present invention to provide an airport anti-collision system that addresses the above-mentioned concerns.

In accordance with one aspect, the present invention provides a system for avoiding aircraft and airport collisions comprising:

a ground based monitoring station serving as one port of a wireless LAN operating according to a wireless communications protocol compatible with the IEEE 802.16e standard and derivatives thereof;

a database containing static position data of an infrastructure of said airport;

a respective mobile unit associated with each mobile object authorized to operate within a monitored area of airspace for producing respective position-dependent signals and for communicating said signals to the ground based monitoring station and to respective mobile units associated with other mobile units via said wireless LAN;

a collision prediction unit in communication with the ground based monitoring station and each being responsive to respective position-dependent signals received from all of said mobile units as well as to said static position data for predicting collisions between mobile objects or between a mobile object and said infrastructure; and

a warning unit coupled to the collision prediction unit and responsive to a predicted collision involving one or more mobile objects for conveying a respective warning to the one or more mobile objects for allowing evasive action.

In accordance with another aspect, the present invention provides a method for avoiding aircraft and airport collisions, the method comprising:

maintaining a database containing static position data of an infrastructure of said airport;

periodically communicating a respective position signal from a respective mobile unit associated with each mobile object authorized to operate within a monitored area of airspace to a ground based monitoring station serving as one port of a wireless LAN operating according to a wireless communications protocol compatible with the IEEE 802.16e standard and derivatives thereof;

using respective position-dependent signals received from all of said mobile units as well as said static position data to predict collisions between mobile objects or between a mobile object and said infrastructure; and

responsive to a predicted collision involving one or more mobile objects conveying a respective warning to the one or more mobile objects for allowing evasive action.

The wireless LAN may include a link to one or more satellites operating in accordance with the WiMAX standard. In order to avoid interference between mobile units within mutual broadcast range transmitting to different satellites, mobile units are preferably divided into subsets. Each subset is defined in a manner that limits the maximal time delay between its members, for their unified uplink transmission to the same satellite. This may be done by including in each subset only those mobile units that are geographically close to each other. By such means, it may be ensured that the relative time delay between mobile units of one subset to a certain satellite does not exceed the guard interval. However, the relative delay between subsets may exceed the guard interval.

Two or more satellites may handle the respective mobile units in each subset, thus allowing satellite diversity by allocating subsets to different time and/or frequency resources. As a result, fewer interferences will occur and weak uplink transmissions may be better received at the satellites. Despite the S-WiMAX satellite diversity, the communication may be better synchronized, in the time domain, to each satellite.

The problem of large relative delay between users may be significantly reduced, as subsets are defined in a manner to assure the time delay between mobile units in one subset remains smaller than the guard interval of the OFDM symbols. Thus inter-symbol interference is also prevented or significantly reduced.

This way, mobile units in any given subset do not cause inter-symbol interference with each other, and reception may be conducted in the standard WiMAX fashion. Any problem of inter-symbol interference is then limited to between subsets, which can be partitioned to allow efficient uplink.

Large frequency offsets due to Doppler shift may be compensated for by increasing the subcarrier spacing by reducing the FFT size. This of course also decreases the guard interval (a classical tradeoff in OFDM). In near line-of-sight scenarios, it is usually possible to allow reduction of the guard interval which is aimed at eliminating inter-symbol-interference.

Alternatively, a frequency tracking and compensation mechanism is employed at the base station (which may be based on the same guidelines as that incorporated into the mobile platform). Since the IEEE802.16e standard does not dictate the means to combat frequency offset, so there is no restriction in the 802.16e to employ such a mechanism. However, very large Doppler shifts may restrict the uplink transmission scheme in a way that different mobile platforms may need to use certain time-frequency allocations.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is graphical representation illustrating the extent of airport collisions in the USA during the years 2005-2006;

FIG. 2 is a pictorial representation of an airport anti-collision system according to an embodiment of the invention;

FIG. 3 is a block diagram showing functionality of a transponder for tracking moving objects in the system shown in FIG. 2;

FIG. 4 is a pictorial representation of a cockpit unit displaying potential collisions;

FIG. 5 is a block diagram showing functionality of a central unit for tracking moving objects in the system shown in FIG. 2;

FIG. 6 is a pictorial representation illustrating collision prediction and relaying to cockpits of colliding aircraft for allowing evasive action;

FIGS. 7 to 11 are flow diagrams showing details of the flight dispatch process used in conjunction with the system illustrated in FIG. 2;

FIG. 12 is a pictorial representation relating to an improved wireless communications protocol for use with the invention according to one embodiment;

FIG. 13 shows graphically a frequency-time characteristic for OFDM symbols relating to the communications protocol shown in FIG. 11;

FIG. 14 is a flow chart relating to operation of the communications protocol shown in FIG. 11;

FIGS. 15 and 16 show respectively BER and PER simulation results with a different number of guard band sub-carriers; and

FIGS. 17 to 19 relate to methods for correcting for Doppler shift in accordance with different embodiments of the invention.

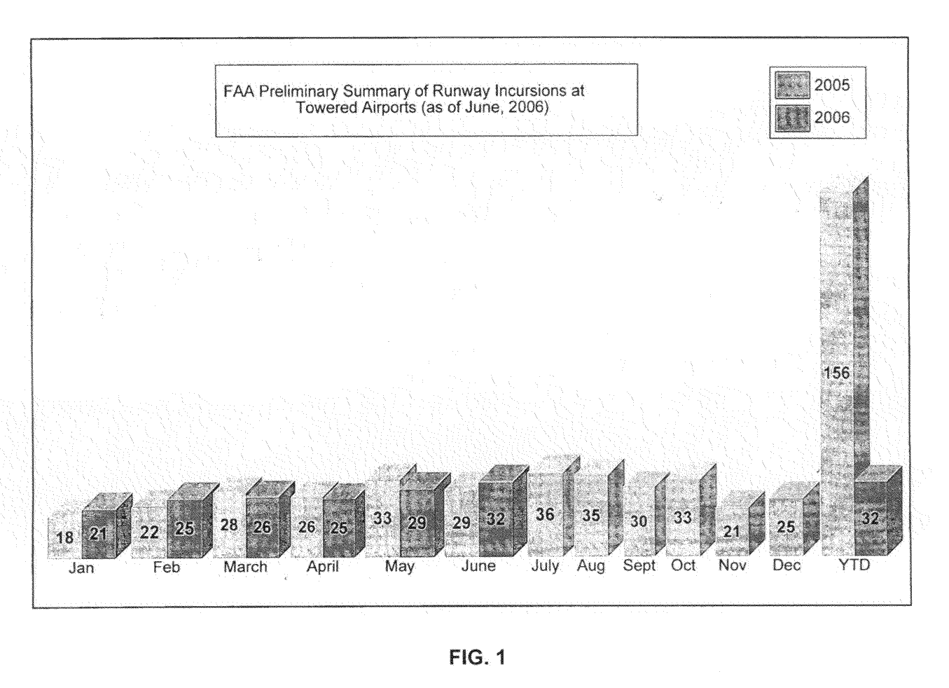

### DETAILED DESCRIPTION OF EMBODIMENTS

In the following description of an embodiment of the invention, components that appear more than once in the drawings will be referenced by common numerals. Components that appear more than once in the same drawing will be referenced by a common base numeral (e.g. 12) and different instances will be suffixed ‘a’, ‘b’, ‘c’ etc. Where such components are referred to generically, they will referenced by the base numeral.

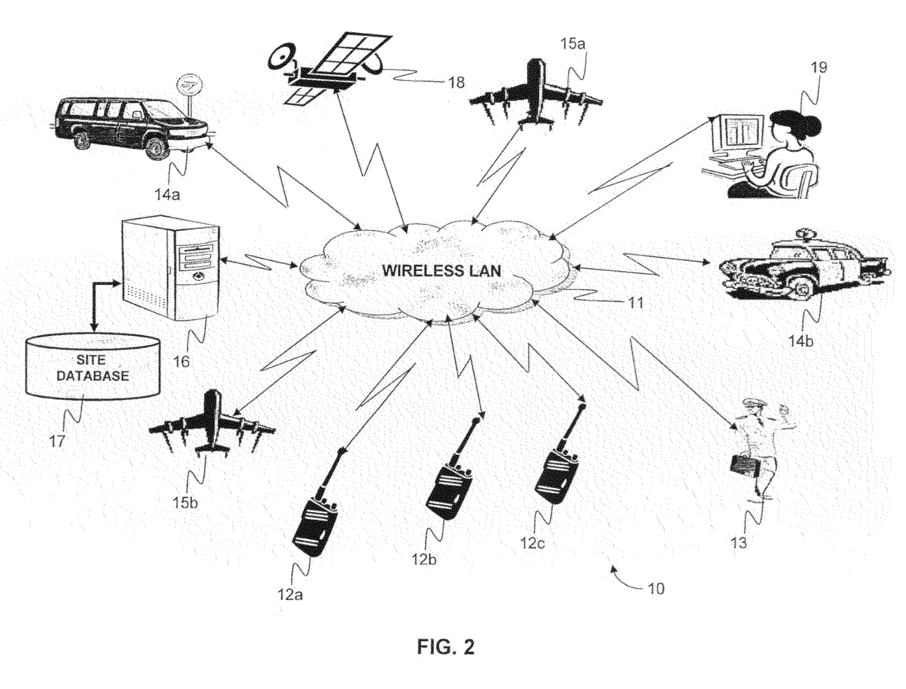

FIG. 2 is a pictorial representation showing schematically an airport anti-collision system 10 comprising a wireless LAN 11 and a plurality of mobile trans-ponders (also referred to as subscriber units or mobile units) 12a, 12b and 12c that may be carried by personnel 13 or by service vehicles 14a and 14b. Similar mobile transponders may likewise be embedded within aircraft 15a and 15b. The transponders 12 may be mounted in the service vehicles 14 and aircraft 15 or their functionality may be built into the electronics of the service vehicles 14 and aircraft 15.

A RTTP (real time tracking position) computer 16 (also referred to as a central unit) is connected to the wireless LAN 11 and to a site database 17 storing data pertaining to the airport infrastructure. Such data includes locations of fixed structures such as runways, buildings control towers and the like. The location data in the site database 17 allows the spatial coordinates of all fixed structures to be mapped so that in use of the system 10, collisions can be predicted not only between moving objects but also between an aircraft and a fixed structure within the airport complex.

The wireless LAN 11 may include a satellite link 18 that supplements the wireless LAN 11 and allows communication also to objects, particularly aircraft that may be out of broadcast range of the wireless LAN 11. The satellite link 18 may also be used to provide GPS data in known manner so that the absolute instantaneous spatial locations of all moving objects may be determined and communicated to the wireless LAN 11 and hence to the computer RTTP 16. In accordance with some embodiments of the invention, a customized version of the s-WiMAX protocol that reduces time delays and enables timely alerts and evasive action even for aircraft during takeoff or landing at high speed. This is described with particular reference to FIGS. 11 to 15 of the drawings.

A critical feature of the present invention is that the bandwidth, speed and range of the wireless LAN 11 must be sufficiently high to allow simultaneous communication in real time between the RTTP computer 16 and possibly hundreds of multiple moving objects such as personnel 13, service vehicles 14 and aircraft 15. This requirement is met in accordance with an embodiment of the invention by using a WiMAX LAN providing high-speed mobile data and telecommunications services, also known as 4-G or fourth generation networks that operate on Internet technology combined with other applications and technologies such as WiMAX, and runs at speeds of at least 1 Gbit/sec.

It should be noted that WiMAX does not itself define one specific standard but is a term coined to describe standard, interoperable implementations of IEEE 802.16 wireless networks some of whose principal features will now briefly be described.

MAC Layer

The 802.16 MAC (Media Access Controller) uses a scheduling algorithm for which the subscriber station need compete once (for initial entry into the network). After that it is allocated an access slot by the base station. The time slot can enlarge and contract, but remains assigned to the subscriber station which means that other subscribers cannot use it. The 802.16 scheduling algorithm is stable under overload and over-subscription (unlike 802.11—commonly referred to as WiFi). It can also be more bandwidth efficient. The scheduling algorithm also allows the base station to control QoS parameters by balancing the time-slot assignments among the application needs of the subscriber stations.

Physical Layer

The original WiMAX standard (IEEE 802.16) specified WiMAX for the 10 to 66 GHz range. 802.16a, updated in 2004 to 802.16-2004 (also known as 802.16d), added specification for the 2 to 11 GHz range. 802.16d (also known as “fixed WiMAX”) was updated to 802.16e in 2005 (known as “mobile WiMAX”), and uses scalable orthogonal frequency-division multiplexing (OFDM) as opposed to the OFDM version with 256 sub-carriers used in 802.16d. This brings potential benefits in terms of coverage, self installation, power consumption, frequency re-use and bandwidth efficiency. 802.16e also adds a capability for full mobility support. The WiMAX certification allows vendors with 802.16d products to sell their equipment as WiMAX certified, thus ensuring a level of interoperability with other certified products, as long as they fit the same profile.

Broadband Access

WiMAX subscriber units are available in both indoor and outdoor versions from several manufacturers. Indoor units are comparable in size to a cable modem or DSL modem. Outdoor units allow for the subscriber to be much further away from the WiMAX base station.

The WiMAX specification provides increased bandwidth and range and stronger encryption. It provides connectivity between network endpoints without the need for direct line of sight in favourable circumstances. The non-line-of-sight propagation (NLOS) performance requires the 0.16d or 0.16e revisions, since the lower frequencies are needed and relies upon multi-path signals.

Standards

The current 802.16 standard is IEEE Std 802.16e-2005[1], approved in December 2005. It followed on from IEEE Std 802.16-2004[2], which replaced IEEE Standards 802.16-2001, 802.16c-2002, and 802.16a-2003.

IEEE Std 802.16-2004 (802.16d) addresses only fixed systems. 802.16e adds mobility components to the standard. It is thus the 802.16e standard that is currently most relevant to the present invention and will now be discussed in more detail.

IEEE 802.16e

IEEE 802.16e-2005 (formerly named, but still best known as, 802.16e or Mobile WiMAX) provides an improvement on the modulation schemes stipulated in the original (fixed) WiMAX standard. It allows for fixed wireless and mobile Non Line of Sight (NLOS) applications primarily by enhancing the OFDMA (Orthogonal Frequency Division Multiple Access).

SOFDMA (Scalable OFDMA) improves upon OFDM256 for NLOS applications by:
Improving NLOS coverage by utilizing advanced antenna diversity schemes, and hybrid-Automatic Retransmission Request (hARQ);
Increasing system gain by use of denser sub-channelization, thereby improving indoor penetration;
Introducing high-performance coding techniques such as Turbo Coding and Low-Density Parity Check (LDPC), enhancing security and NLOS performance;
Introducing downlink sub-channelization, allowing administrators to trade coverage for capacity or vice versa;
Improving coverage by introducing Adaptive Antenna Systems (AAS) and Multiple Input Multiple Output (MIMO) technology;
Eliminating channel bandwidth dependencies on sub-carrier spacing, allowing for equal performance under any RF channel spacing (1.25-14 MHz).

Enhanced Fast Fourier transform (FFT) algorithm can tolerate larger delay spreads, increasing resistance to multipath interference.

Although the description so far relates specifically to WiMAX and to IEEE 802.16 standard in general and to IEEE 802.16e in particular it should be noted that any wireless LAN that is compatible with these standards may also be used. In this context, it is to be noted that the equivalent of 802.16 in Europe is HIPERMAN. The WiMAX Forum is working to ensure that 802.16 and HIPERMAN inter-operate seamlessly. Likewise, Korea's electronics and telecommunication industry spearheaded by Samsung Electronics and ETRI has developed its own standard, WiBro. In late 2004, Intel and LG Electronics agreed on interoperability between WiBro and WiMAX. It is therefore to be understood that reference to WiMAX is not intended to be limiting.

Consider the case where a vehicle arriving on the service road is about to intersect the path of an aircraft, thus constituting a threat to the safety of the aircraft. The aircraft continually transmits its location over the WiMAX LAN by means of an on-board transponder 12 equipped with an electronic flying bag unit (EFB) that is basically a laptop computer having a display screen. An aircraft that is not fitted with a module 12 may still be picked up by field radar via an Automatic Dependent Surveillance-Broadcast (ADS-B) or Mode-S ground station. The data are received by a WiMAX base station and/or by the ADS-B ground station and from there are conveyed to the RTTP computer. The field radar data are conveyed via the RDP to a CIMACT station and from there are relayed to the RTTP computer. CIMACT is an abbreviation of Civil/Military ATM/Air Defence Coordination Tool details of which can be found at http://www.eurocontrol.int/epr/public/subsite_homepage/homepage.html, which is Eurocontrol's website. The flight plan is fed to the database of the RTTP computer. The RTTP computer correlates the data received from all the sensors to obtain the ID of each object and avoid duplication of objects. The database is the heart of the system in that the data stored therein is used by the anti-collision algorithms to predict collisions both between moving objects and between a moving object and a fixture of the airport infrastructure.

In this event that the system detects that a potential collision is about to occur, the following actions are taken simultaneously:
The system creates an automatic warning message and sends it to the pilot of the threatened aircraft over the Mayday emergency communication channel;
Intruder data are transmitted via WiMAX to the EFB display unit of the threatened aircraft and the pilot's electronic chart (Jepson) displays a picture of the current scene showing the aircraft's location relative to the intruder;
The intruder, which could be the driver of a service vehicle or other authorized personnel equipped with a transponder 12, receives a vocal warning instructing him of what evasive action to take (e.g. HALT, TURN LEFT and so on) and at the same time a speech communication channel is established via the WiMAX OR GSM network of the transponder between the intruder and the air traffic controller 19.
The ground station computer opens a window for the air traffic controller 19, and for the emergency field team showing him a 3-D picture of the area at risk including background objects whose data is stored in the database 17.
Location data are also conveyed to an electro-optical assembly that is moved to the desired direction and a live video of the event is broadcast in real time to the control tower and to the emergency field team.

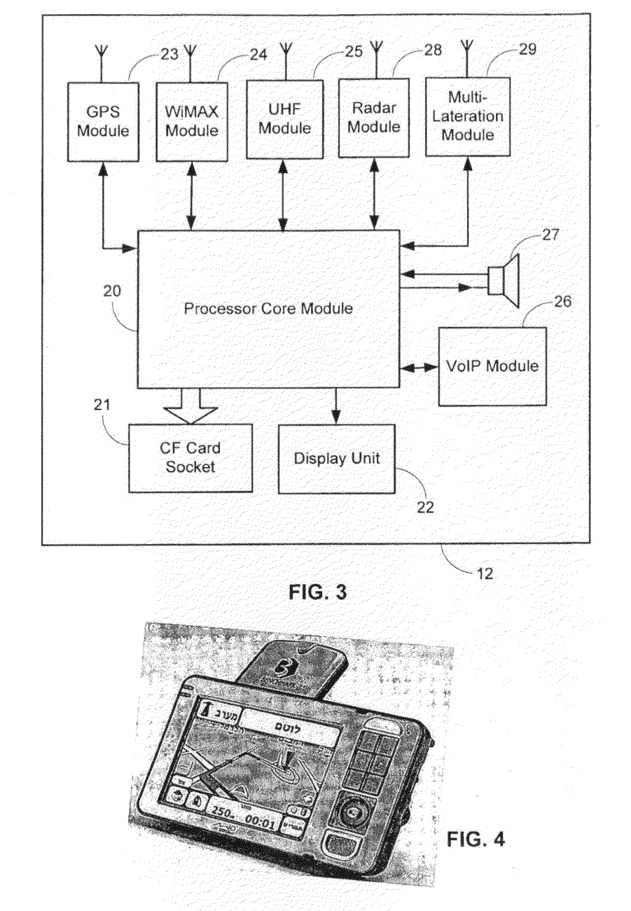

Having described the manner in which the system 10 operates, the functionality of the transponder or subscriber unit 12 shown in FIG. 2 will now be described. Thus, referring to FIG. 3 showing a block diagram of the transponder 12, it is seen that the transponder 12 has a processor core module 20 coupled to a CF or SD card socket 21 or USB that allows connection to a pocket PC (not shown). A display unit 22 is coupled to the processor core module 20 for displaying data that may include a pictorial layout of the airport in the immediate vicinity of the transponder 12 as shown in FIG. 4 of the drawings. Also connected to the processor core module 20 are a GPS module 23, a WiMAX module 24, a UHF module 25 and a VoIP module 26. A loudspeaker 27 is also coupled to the processor core module 20 for providing vocal messages. Also shown coupled to the processor core module 20 are a radar module 28 and a multilateration module 29. Multilateration is commonly used airport surveillance systems to accurately locate an aircraft, vehicle or stationary emitter by measuring the time difference of arrival (TDOA) of a signal from the emitter at three or more receiver sites. The processor core module 20 may be interfaced to all known systems thus allow data fusion from multiple sensors and sensor types.

FIG. 4 is a pictorial representation of a cockpit unit or a pilot's electronic page unit displaying a potential collision.

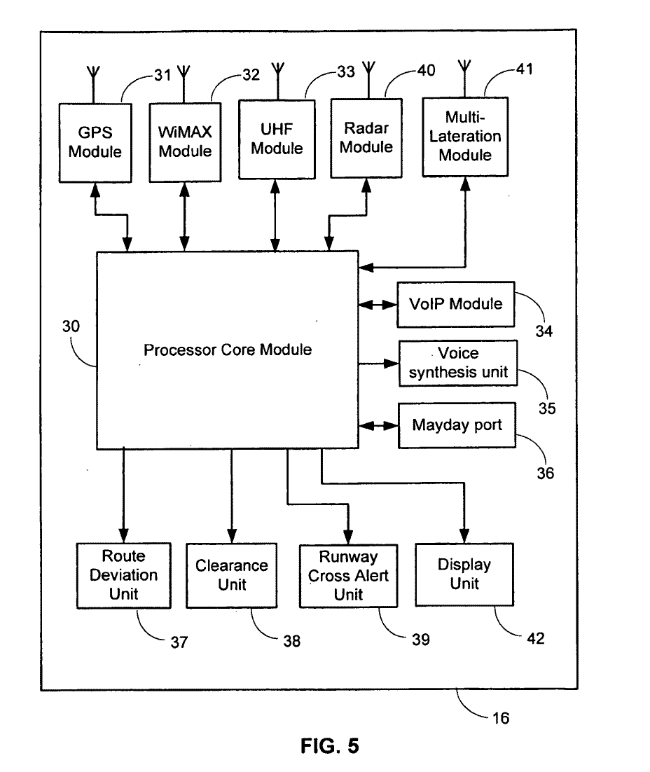

FIG. 5 is a block diagram showing functionality of the real time tracking position computer 16 shown in FIG. 2, which constitutes a central unit for tracking moving objects and providing alerts. The computer 16 has a processor core module 30 coupled a GPS module 31, a WiMAX module 32, a UHF module 33 and a VoIP module 34. A voice synthesis unit 35 is also coupled to the processor core module 30 for synthesizing vocal alerts. Since not all mobile units may be adapted to receive and interpret vocal alerts directly from the RTTP computer 16, the processor core module 30 is also coupled to a Mayday port 36 for communicating to a standard Mayday system that alerts the mobile units in conventional manner.

Also coupled to the processor core module 30 is a route deviation unit 37 responsive to a planned route for a mobile object for providing an alert if an actual route as determined from periodic position data of the object unacceptably deviates from the planned route. A clearance unit 38 coupled to the processor core module 30 is responsive to periodic position data of moving objects and to position data of the infrastructure for computing clearance surrounding the moving objects and providing an alert if the computed clearance is deemed insufficient. A runway cross alert unit 39 coupled to the processor core module 30 is responsive to periodic position data of aircraft and to position data of a runway on which the aircraft has been cleared for takeoff for providing an alert if a runway cross alert is predicted. The runway cross alert unit 39 may further be adapted to compute takeoff and landing speeds of aircraft and to provide an alert if the computed takeoff or landing speed of an aircraft is deemed unsafe for the aircraft based on stored parameters associated with each aircraft. Also shown coupled to the processor core module 30 are a radar module 40 and a multilateration module 41. A display unit 42 coupled to the processor core module 30 displays data that may include a pictorial layout of the airport showing mobile objects that are in risk of collision. The display unit 42 may also show other potentially hazardous or otherwise significant events. For example, mobile transponders 12 carried on board personnel and vehicles bear IDs that may be correlated in the database 17 to access authorization codes. This allows intrusion of personnel or vehicles into areas for which they are not authorized to be monitored and displayed, allowing suitable follow-up to be taken.

It is also to be noted that in accordance with other embodiments, some of the functionality of the computer 16 may be provided also in the mobile units 12. This allows for distributed processing and not only reduces the load on the computer 16 but also reduces the communication overhead in alerting moving aircraft of predicted collisions, thus providing them with more time to take evasive action.

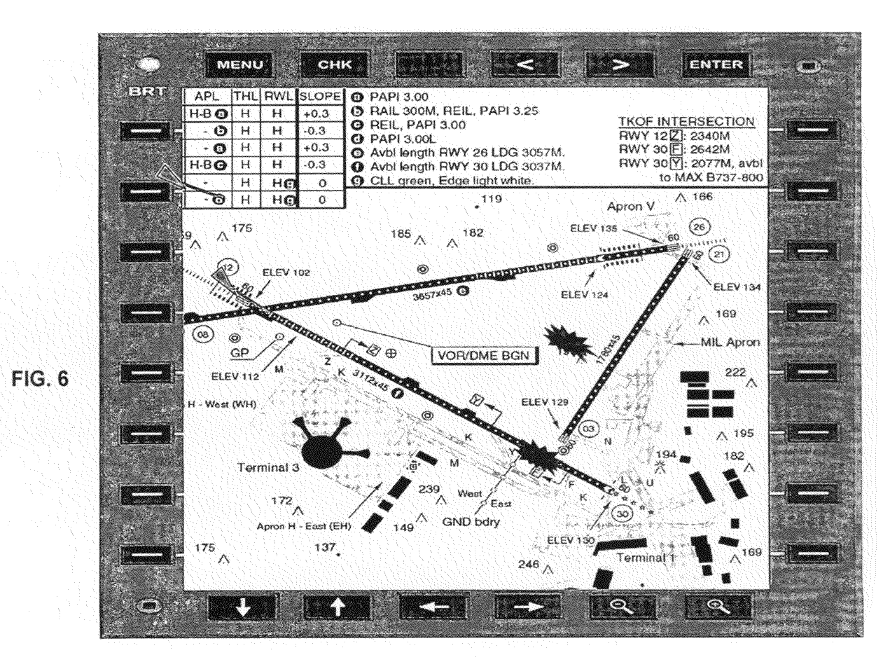

FIG. 6 is a pictorial representation illustrating collision prediction and relaying to cockpits of colliding aircraft for allowing evasive action.

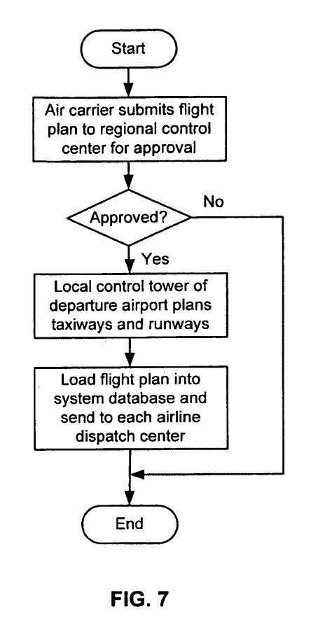

FIGS. 7 to 11 are flow diagrams showing details of the flight dispatch process used in conjunction with the system illustrated in FIG. 2. As shown in FIG. 7, an air carrier submits a flight plan for approval by the regional control center, which approves the flight after internal design of flight path load and determine which path the flight will fly through. The local control tower at the airport from which the submitted flight will depart plans the local load with respect to taxiways and runways. This plan is loaded into the site database 17 (shown in FIG. 2) via the computer 16 that resides within the local tower. Upon flight approval, the approved flight and its data are sent to each airline dispatch center for briefing purposes.

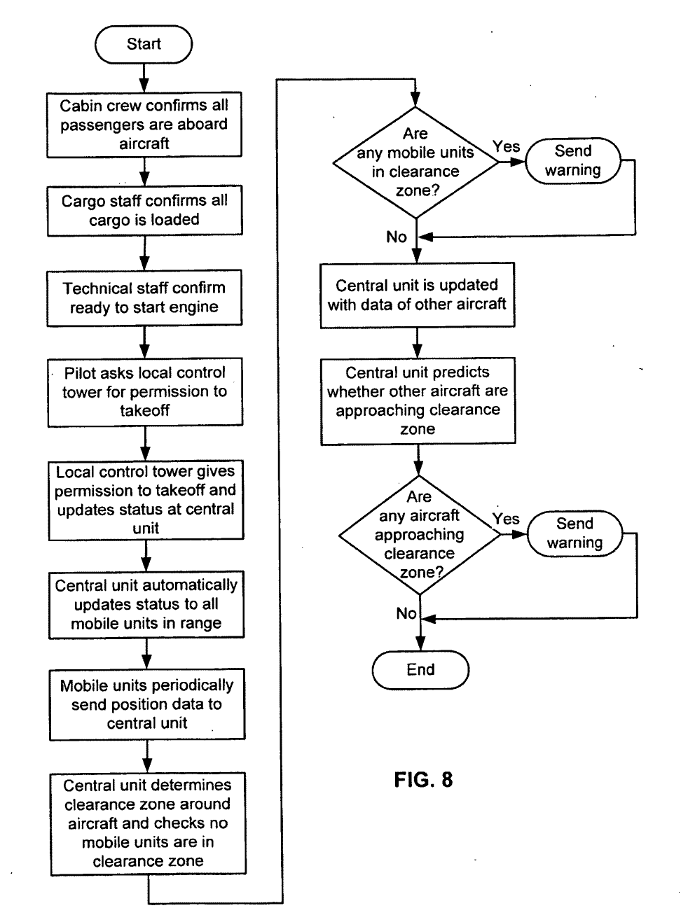

FIG. 8 shows actions that are carried out during a subsequent stage when the aircraft and crew are ready for engine start known as “Push and Start”. When an aircraft is ready for launch, the following notifications should be heard at the cockpit prior to pilot asking the tower for the permission to “Push and Start”:
Cabin Crew (purser/stewardess/steward) confirms that all passengers are aboard the aircraft
Cargo staff confirms complete loading of luggage
Technical team confirms ready for engine start

The air crew/pilot then contact the local control tower via VHF radio for “Push and Start” permission. The local control tower grants “Push and Start” via VHF radio and amends the system status to “Push and Start”, which then the central unit sends the updated status to all mobile units. While the “Push and Start” status holds, all units periodically check the following parameters affected by the Push and Start clearance zone as determined for the type of aircraft and its location:
No unauthorized personnel or vehicles are present in a clearance zone around the aircraft.
Position data of the relevant units are received by the central unit and tested against the clearance zone.
No other aircraft approaches the required clearance zone.

Data of other aircraft are received by the central unit. The other aircraft may or may not have mobile units 12. If they do, then their position and speed data are conveyed to the aircraft unit directly via the LAN 11. Otherwise, they communicate their position and speed to the local control tower in conventional manner and the data are relayed to the aircraft unit by the local control tower the central unit. This can be done either automatically or manually. A prediction model is used to verify that no other aircraft is approaching the clearance zone. The mobile units set the required distances in accordance with the type of object associated with the mobile unit (aircraft, personnel, vehicle, etc.). Using the Push and Start clearance zone parameters, the aircraft unit checks for available clearance surrounding the aircraft and provides any relevant alert to any object that is on a predicted collision course.

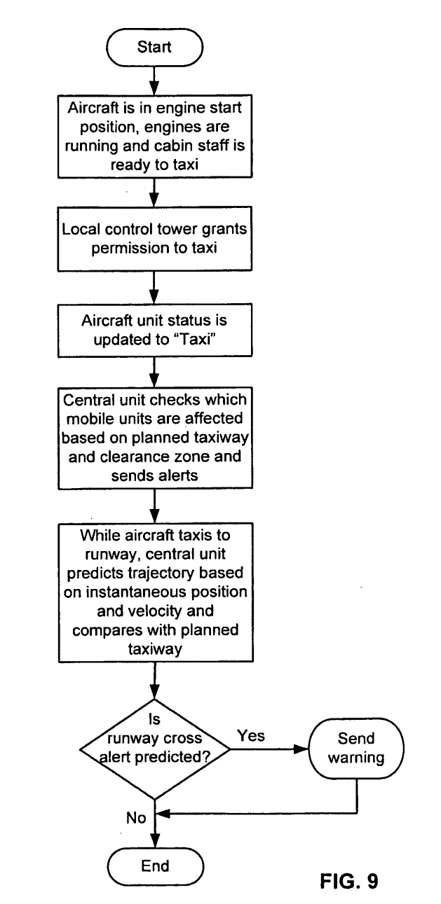

FIG. 9 shows actions that are carried out during a subsequent stage when the aircraft and crew are ready for taxi. The aircraft is ready for taxi when the aircraft has been pushed back to its engine start position, the engines are running and the cabin is ready for taxi. The following actions are then taken:
Air crew contacts the local control tower via VHF radio for permission to taxi.
The local control tower grants permission to taxi via VHF radio and amends the system status to “Taxi”. The central unit may receive an automatic “Taxi” routing from an available system (e.g. Transtech—DCMS), from position change (e.g. change in GPS and/or INS) while engines are running.

Upon status change to “Taxi” the central unit system checks the following parameters affected by the Taxi clearance zone and provide alerts to affected mobile units:
Central unit incorporates the planned taxiway routing
Aircraft unit change status to “Taxi” upon receiving status change from the local control tower.

While the “Taxi” status holds, the aircraft unit checks that the aircraft is taxiing on the proper, designated runway. The position and velocity of the aircraft are used for prediction of its trajectory for a given period of time. This trajectory is compared to the preloaded data of the designated runway.

It also periodically checks which mobile units are affected based on the planned taxiway and clearance zone and provides a runway cross alert if any other aircraft is predicted to taxi, land or take off in its path. A prediction model, based on other aircraft dynamic data and status, is used. It likewise checks for, and if necessary alerts, other units that might approach the designated taxiway/runway from any direction that is not approved. The trajectory of vehicles is predicted based on their dynamic data, type and the road map of the airport. The road map of the airport will also show temporary obstacles such as a blocked runway or taxiway as well as permanent obstacles such as a runway or taxiway under construction.

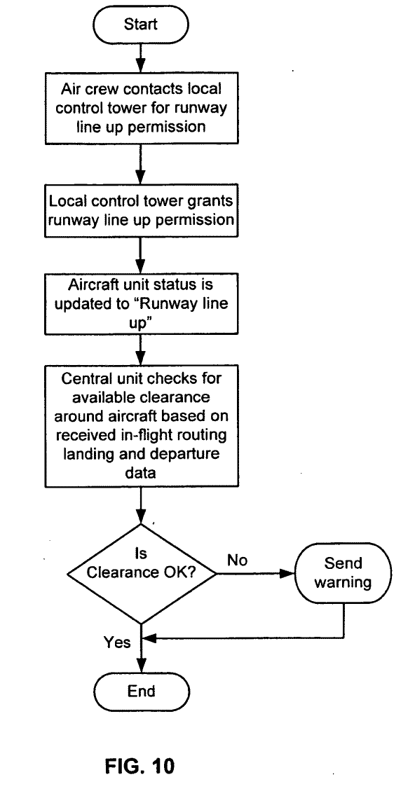

FIG. 10 shows actions that are carried out during a subsequent stage when the aircraft and crew are ready for runway (RWY) lineup. The following actions are then taken:
Air crew contacts the local control tower via VHF radio for “RWY Line Up” permission.
The control tower grants “RWY xx Line Up” via VHF radio and amends the status of the aircraft unit to “RWY xx Line Up” and/or the central unit receives an automatic “RWY xx Line Up” from an available system (e.g. Transtech—DCMS)

The control tower includes the specific runway designation (“xx”) and initial flight routing/departure path (SID). The central unit checks for available clearance surrounding the aircraft and provides any relevant alert for the air crew (if required). To this end, the central unit uses a prediction model based on dynamic data and status of other aircraft to check that:
Landing is not in progress for the designated runway.
Takeoff is not in progress for the designated runway (another line up spot).

FIG. 11 shows actions that are carried out during a subsequent stage when the aircraft and crew are ready for takeoff. The following actions are then taken:
Air crew contacts the local control tower via VHF radio for “Flight ##Ready for Takeoff” and awaits tower permission.
The control tower grants “Flight ## Takeoff RWY xx” via VHF radio and amends the status of the aircraft unit to “Flight ## Takeoff RWY xx” and/or the aircraft unit receives an automatic “Flight ## Take Off RWY xx” from an available system (e.g. Transtech—DCMS)
The control tower grants “Flight ## Takeoff RWY xx” including specific initial flight routing/departure path (SID).

Upon permission for takeoff being granted by the control tower, the central unit system checks for available clearance surrounding the aircraft and, if necessary, provides relevant alert for the air crew as well as other mobile units. To this end, the central unit system uses a prediction model based on dynamic data and status of other aircraft to check that:
Landing is not in progress for the designated runway.
Takeoff is not in progress from a different line-up location for the designated runway (another line up spot).

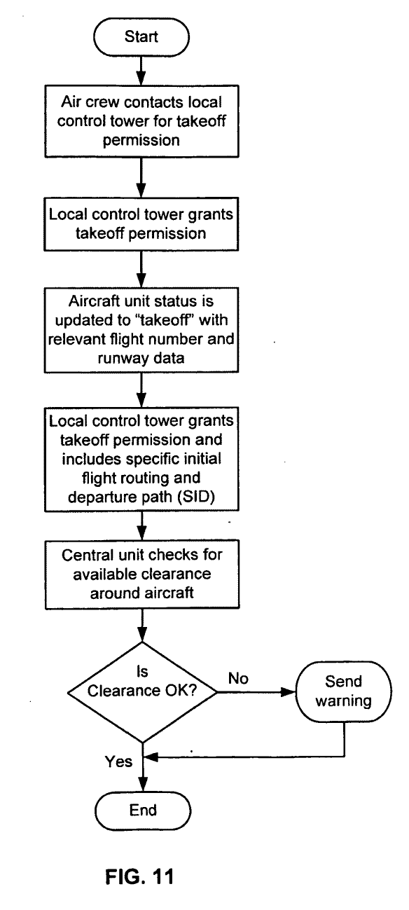

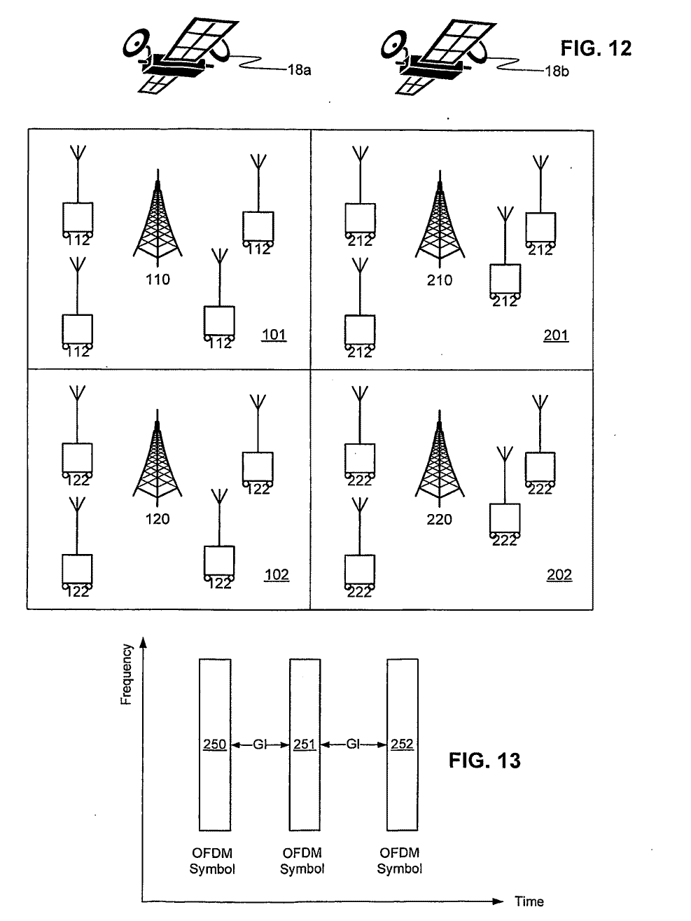

There will now be described with reference to FIGS. 12 to 16 an improved wireless communications WiMAX protocol in accordance with an embodiment of the invention.

FIG. 12 is a pictorial representation of an S-WiMAX communication system with two satellites 18a and 18b. Mobile units 112, 122, 212, 222 are divided into subsets 101, 102, 201 and 202 respectively. In each of the subsets 101, 102, 201, 202 there may be one or more base stations 110, 120, 210, 220 respectively. Each satellite 18a and 18b may communicate with only one of the base stations, and the mobile units may communicate with their associated terrestrial base station and/or via any of the satellites.

In one embodiment, the subsets are allocated to ensure that the time delay to one or more satellites is smaller than the guard interval, thus eliminating an inter-symbol interference within the subset, as detailed in FIG. 13. Thus, OFDM signals 251, 251 and 253 forming part of an OFDM uplink, do not interfere each other as the differential delay is smaller than the guard interval. It may be simpler to perform FFT operations within a subset, reducing costs and uplink-to-satellite complexity, while overall management of subsets may be maintained by any one or more of the base stations.

The timing of OFDM symbols 251, 252 and 253 for the S-WiMAX system may allow the satellite trace each of the OFDM symbols of a certain subset within its guard interval. Communication to a base station may be initiated either directly, or through a satellite, or combined. When mobile units are dispersed over a wide area, some of them may be out of reach of a base station. They can then connect to the base station via a satellite. Yet, mobile units may know to which subset they belong based on initial definition, notification from a satellite or base station, and/or by calculating its location.

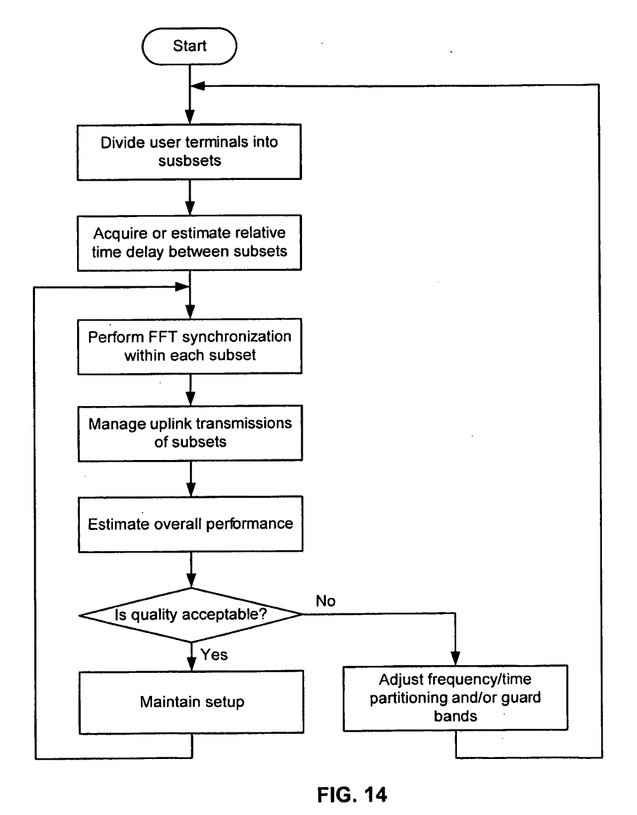

FIG. 14 shows operations carried out in accordance with one embodiment for maintaining satellite diversity for a WIMAX system. A set of mobile units or users is divided into subsets. Each set is devised such that the maximal time delay between its members does not exceed the guard interval length. Thus, the users that are members of the same subset are actually close geographically. This may be combined to match either one of the satellites or both. The relative delay between subsets may exceed the guard interval length. This way, users in a certain subset do not cause inter-symbol interference to each other, and reception of one subset may be conducted in the standard WiMAX fashion. Any problem of inter-symbol interference is then limited to between subsets, while being reduced at the subset level.

One or more base stations and/or satellites acquire information or estimation regarding relative delay between subsets, which is assumed as time invariant. This data may be used to later combine transmissions of subsets. A different FFT operation can be performed for each subset, and the time alignment of the FFT can be based on the knowledge of the relative delay associated with the specific subset.

In order to decrease the interference in the frequency domain between subsets, which arises from the lack of orthogonality, it may be possible to adjust and/or define disjoint frequency bands for each subset and partition them, such as by using a small number of sub-carriers guard-bands.

This way, even though the signals belonging to different subsets are no longer orthogonal, the interference may be significantly reduced. It should be further noted that it is assumed that the system operates at the regime of low SNR, so that the interference should be kept small with respect to the link SNR. Overall estimation can be performed, to decide whereas to maintain current setup, or alternatively to adjust frequency/time partitioning and/or guard bands, which might be resource consuming. Accordingly, better performance can be achieved over time, adjusting frequency-time resources with subsets.

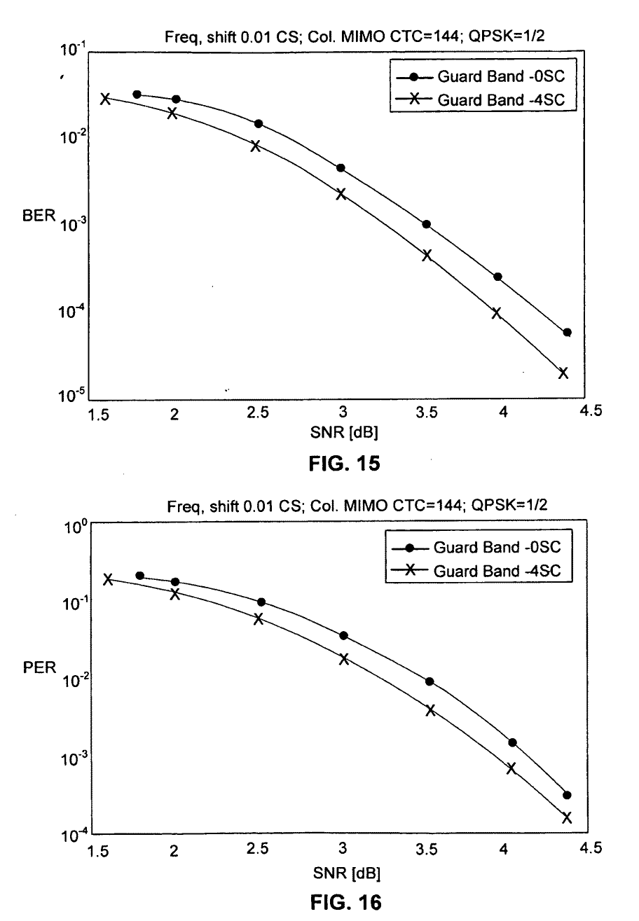

FIGS. 15 and 16 show respectively BER (Bit Error Rate) and PER (Packet Error Rate) simulation results with a different number of guard band sub-carriers. Simulation estimates for collaborative MIMO (Multiple Input Multiple Output) allocation may include FEC (Forward Error Correction) size of 72 bits, for example.

The results need not depend strongly on that allocation, and four subsets of users may be assumed wherein the maximal differential delay is smaller than the guard interval length. The inter subset maximal differential delay may exceed the guard interval length.

The BER and PER results in the simulation are effected by three cases of inter set guard band sizes: 0, 4 and 10 subcarriers. The graphs show that in the case of no guard band, there exists a degradation of approximately 0.3 dB in BER with respect to the perfectly aligned case. The graphs further show that in the case where the guard band is larger than four subcarriers the performance degradation in negligible. Thus, it may be possible to initiate various test and measurement approaches, to define acceptable BER and/or PER, and set guard bands or use other means accordingly.

In one embodiment, the 802.16e was used with guard interval=118 μS. The base stations are WiMAX compatible; the terrestrial base stations may include standard WiMAX equipment, while the base station that communicates through the satellite link is S-WiMAX adapted.

The S-WiMAX deployment may include the definition of subsets according to geographical considerations. The S-WiMAX and terrestrial base station, which are fixed geographically, may have this information. Any mobile unit or equipment endowed with a GPS receiver may be able to determine the location according to a pre-defined database. The terrestrial base station can inform the mobile unit of the subset it is in. The allocation can be done according to the spot beams of each satellite. That may be done according to the geographical position of the mobile unit. Mobile unit users are assumed to be mobile. Thus handover from terrestrial base station to the S-WiMAX 13S may be essential.

In one embodiment, the satellites may be geo-stationary so no movement with respect to the earth's surface might be sensed. The actual area covered can be very large, thus it is divided into regions that correspond to subsets in a manner that the maximal differential delay between two users within a subset does not exceed the guard interval duration.

More than two satellites may also be used simultaneously with higher diversity.

In order to be able to reach the satellite, the mobile unit may place all of its power on a small number of subcarriers, such as 4 SC's. The allocations are such that the SC's are consecutive in the frequency domain and remain fixed.

In another embodiment, which may be based on simulation, the following may be used:

BW=1.2S MHz, FFT size=512, guard interval=118 μS. Each user may transmit over four consecutive subcarriers along the whole uplink subframe (12 symbols). There are four subsets of users such that the maximal differential delay between users within a subset does not exceed the guard interval duration. Each subset includes numerous users and is allotted a different disjoint band in the frequency domain. In contrast to WiMAX, the base station performs an equal number FFT operations as there are subsets (i.e. four in the example), that differ in the starting point of the FFT (according to the average time delay of each subset).

The purpose of the simulation may be to verify the size of the guard interval (between subsets allocation) necessary to avoid inter-set interference arising from inter-symbols interference owing to lack of temporal synchronization between subsets.

In some embodiments, the satellite link may form an FDD communication link. This means that the uplink and downlink are transmitted at different frequencies. In contrast, the WiMAX adopts the TDD concept, in which the uplink and downlink are transmitted about the same frequency in different time intervals. Thus, in S-WiMAX a half FDD scheme is suggested wherein the uplink and downlink signals are transmitted using different frequencies as well as different time intervals.

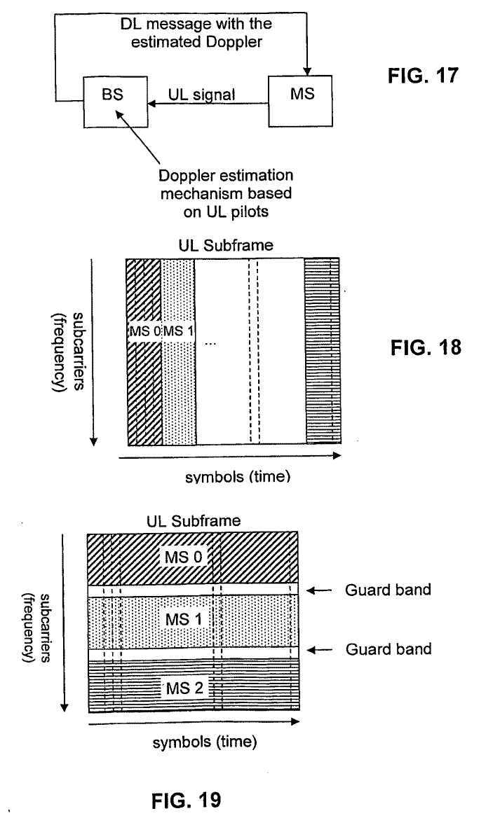

FIGS. 17 to 19 relate to methods for correcting for Doppler shift in accordance with different embodiments of the invention. There is first described (a) a common practice approach that may be applied together with the novel methods (b) to (d) that are not supported in the IEEE802.16e standard and thus require that changes to the standard be effected.

(a) FFT Size Reduction

Terrestrial WiMAX is optimized for non-line-of-sight (NLOS) scenarios with limited mobility. Thus, for a fixed guard-interval overhead (defined as a fraction of the OFDM symbol length), there exists a natural tradeoff between larger guard interval (to accommodate large delay spread due to multipath), and larger subcarrier spacing (to accommodate large residual frequency offsets). Specifically, the OFDM symbol length Tₛ is given by

$${T}_{s} = \frac{{N}_{fft}}{{F}_{s}} , \qquad ( 2 )$$

where: Fₛ is the sampling frequency (which is approx. the occupied bandwidth),
and N_{fft} is the FFT size.

The guard interval length T_{gi} is then give by:

$${T}_{gi} = {α}_{gi} {T}_{s} = {α}_{gi} \frac{{N}_{fft}}{{F}_{s}} , \qquad ( 3 )$$

where: α_{gi} is the ratio between the guard interval length and the symbol length (usually about 1/8).

Note that the subcarrier spacing ΔSC is given by:

$$Δ SC = \frac{{F}_{s}}{{N}_{fft}} = \frac{1}{{T}_{s}} , \qquad ( 4 )$$

which means that for a fixed α_{gi} (that implies fixed guard interval overhead), the guard interval length and the subcarrier spacing are inversely proportional.

In the aforementioned application the scenario is near line-of-sight in which the expected delay spread is small, so it is possible to reduce the FFT size and the symbol duration. This means that the subcarrier spacing is increased and the system is more resilient to residual frequency offset. The FFT reduction method may be applied together with the other more sophisticated methods listed below.

(b) Pilot Based Closed-Loop Doppler Correction

Another method to combat uplink Doppler is to incorporate a closed-loop uplink Doppler correction mechanism. In this method, the base station estimates the Doppler shift corresponding to each mobile station using the transmitted uplink pilots, and informs the mobile station (through downlink signaling) to compensate for the frequency shift. The downlink messaging is performed whenever the base station estimates a shift that is larger than a predefined threshold, and the corresponding compensation is performed by the mobile station in the coming uplink subframes. The closed-loop Doppler correction method is depicted in FIG. 17.

A closed-loop mechanism is applicable in near line-of-sight scenarios where the Doppler rate is small enough so that the delay implied by the feedback mechanism is admissible.

c) Zone Separation Between Mobile Stations

The problem of Doppler compensation in the uplink is more challenging than that in the downlink owing to the fact that the uplink consists of transmission from multiple mobile station each with its own Doppler shift (compared to the downlink in which there exists a single shift to be compensated).

A method to relax the uplink problem is to separate the mobile stations' transmission in the time domain, such that each mobile station transmits in a different zone (the zones are defined on disjoint support in the time domain). Such a transmission is depicted in FIG. 18 showing vertical allocations with zone separation between mobile stations.

This way, at each zone the frequency shift is that of a single mobile station. The base station estimates the single shift through the transmitted pilots (post FFT) and compensates for it. For simplicity, the compensation may be performed at the next frame. In case, the Doppler rate is high, the compensation may be done in the same frame post FFT (by means of interpolation in the frequency domain), or pre-FFT, by multiplication of the temporal series x(n) with:

$$exp ( j \frac{2 π}{{N}_{fft}} \cdot Δ k \cdot n ) \qquad ( 5 )$$

where: Δk is the frequency offset divided by subcarrier spacing.

Note that the second approach implies two FFT operations, since the frequency shift estimation is post FFT and the temporal series is pre-FFT. The zone separation method is applicable in the case where the uplink link budget allows the mobile station to transmit about the whole frequency band.

(d) Guard Band Insertion Between Mobile Stations

In the case where the link budget does not allow the application of the previous method, the base station may create horizontal uplink allocations and separate them by the insertion of guard-bands. The guard bands are inserted in order to combat the lack of orthogonality arising from the different Doppler shifts pertaining to different mobile stations. The guard bands allow the signal transmitted by one mobile station to decay sufficiently and cause negligible inter-carrier-interference to the signal transmitted by another mobile station. The horizontal transmissions separated by guard bands is depicted in FIG. 19.

The base station estimates the frequency shift corresponding to each mobile station through the pilots, similarly to the previous methods. However, in this method each OFDM symbol is affected by multiple frequency shifts, so the compensation must be done either post FFT for each horizontal allocation independently (by means of interpolation in the frequency domain), or by multiplication of the temporal series x(n) with M different series (one for each mobile station)

$$exp ( j \frac{2 π}{{N}_{fft}} \cdot Δ {k}_{i} \cdot n ) \qquad ( 6 )$$

where Δkᵢ, i=0 . . . M−1, is the frequency offset of the i-th mobile station divided by subcarrier spacing.

This invokes the FFT operation M+1 times. When this method is combined with the FFT reduction method depicted in (a) above, the FFT size is small so the overall complexity may remain very reasonable.

It will be appreciated that modifications will occur to those skilled in the art upon reading the disclosure set forth hereinbefore and the scope of protection embraces all such modifications as are defined by the scope of the claims and equivalents thereof.

It will also be understood that the components in the system according to the invention may be or include suitably programmed computers. Likewise, the invention contemplates a computer program being readable by a computer for executing the method of the invention. The invention further contemplates a machine-readable memory tangibly embodying a program of instructions executable by the machine for carrying out the method of the invention.

1. An system (10) for avoiding aircraft and airport collisions comprising:
a ground based monitoring station (16) serving as one port of a wireless LAN operating according to a wireless communications protocol compatible with the IEEE 802.16e standard and derivatives thereof;
a database (17) containing static position data of an infrastructure of said airport;
a respective mobile unit (12) associated with each mobile object authorized to operate within a monitored area of airspace for producing respective position-dependent signals and for communicating said signals to the ground based monitoring station and to respective mobile units associated with other mobile units via said wireless LAN;
a collision prediction unit (16) in communication with the ground based monitoring station and each being responsive to respective position-dependent signals received from all of said mobile units as well as to said static position data for predicting collisions between mobile objects or between a mobile object and said infrastructure; and
a warning unit (35, 36, 37, 38, 39) coupled to the collision prediction unit and responsive to a predicted collision involving one or more mobile objects for conveying a respective warning to the one or more mobile objects for allowing evasive action.

2. The system according to claim 1, further including a route deviation unit (37) responsive to a planned route for at least some of the mobile objects and providing an alert if an actual route as determined from periodic position data of the object unacceptably deviates from the planned route.

3. The system according to claim 1 or 2, further including a clearance unit responsive (38) to periodic position data of moving objects and to position data of the infrastructure for computing clearance surrounding the moving objects and providing an alert if the computed clearance is deemed insufficient.

4. The system according to any one of claims 1 to 3, further including a runway cross alert unit (39) responsive to periodic position data of the aircraft and to position data of a runway on which the aircraft has been cleared for takeoff for providing an alert if a runway cross alert is predicted.

5. The system according to claim 4, wherein the runway cross alert unit (39) is adapted to compute takeoff and landing speeds of aircraft and to provide an alert if the computed takeoff or landing speed of an aircraft is deemed unsafe for the aircraft based on stored parameters associated with the aircraft.

6. The system according to any one of claims 1 to 5, further including a respective collision prediction unit in each of the mobile units and in communication with the ground based monitoring station and each being responsive to respective position-dependent signals received from other of said mobile units as well as to said static position data for predicting collisions between the respective mobile object and other mobile objects or between the respective mobile object and said infrastructure.

7. The system according to any one of claims 1 to 6, wherein the warning unit is adapted to:
create an automatic warning message and send it to a pilot of a threatened aircraft over the Mayday emergency communication channel;
transmit intruder data via said wireless communications protocol to a display unit of the threatened aircraft and the display a picture of the current scene showing the aircraft's location relative to the intruder;
illuminate runway lights;
convey a vocal warning to the intruder instructing him of what evasive action to take;
establish a speech communication channel between the intruder and an air traffic controller;
show to the air traffic controller a 3-D picture of the area at risk including background objects whose data is stored in the database; and
convey location data to an electro-optical assembly that is moved to the desired direction and broadcast thereby a live video of the event in real time to the control tower and to the emergency field team.

8. The system according to one of claims 1 to 7, wherein the LAN includes a satellite link for allowing increased broadcast range.

9. The system according to claim 7 or 8, including:
a plurality of subsets each comprising a number of mobile units such that a maximal time delay between mobile units in each subset does not exceed a guard interval duration of the wireless communications protocol;
a respective base station for each subset, each for communicating with the mobile units in said subset; and
one or more satellites communicating with the base stations;
wherein the base stations and satellites are adapted to receive or compute information or estimation regarding relative delay between subsets, to perform for each subset a different FFT each having its own time alignment and to reduce interference in the frequency domain between subsets.

10. The system according to any one of claims 1 to 9, wherein the database contains periodically updated position data of dynamically changing features of the infrastructure of the airport;

11. The system according to claim 10, wherein the dynamically changing features relate to temporary obstacles.

12. The system according to claim 10, wherein the dynamically changing features relate to permanent obstacles.

13. The system according to any one of claims 1 to 12, wherein at least some of the mobile units are smart mobile units including:
a collision prediction unit in communication with the ground based monitoring station and being responsive to respective position-dependent signals received from all of said mobile units for predicting collisions between mobile objects; and
a warning unit coupled to the collision prediction unit and responsive to a predicted collision involving one or more mobile objects for conveying a respective warning to the respective smart mobile unit for allowing evasive action.

14. A method for avoiding aircraft and airport collisions, the method comprising:
maintaining a database (17) containing static position data of an infrastructure of said airport;
periodically communicating a respective position signal from a respective mobile unit associated with each mobile object authorized to operate within a monitored area of airspace to a ground based monitoring station serving as one port of a wireless LAN operating according to a wireless communications protocol compatible with the IEEE 802.16e standard and derivatives thereof;
using respective position-dependent signals received from all of said mobile units as well as said static position data to predict collisions between mobile objects or between a mobile object and said infrastructure; and
responsive to a predicted collision involving one or more mobile objects to conveying a respective warning to the one or more mobile objects for allowing evasive action.

15. The method according to claim 14, further including providing an alert if an actual route of a moving object as determined from periodic position data of the moving object unacceptably deviates from a planned route.

16. The method according to claim 14 or 15, further including computing clearance surrounding the moving objects and providing an alert if the computed clearance is deemed insufficient.

17. The method according to any one of claims 14 to 16, further including computing takeoff and landing speeds of aircraft and to provide an alert if the computed takeoff or landing speed of an aircraft is deemed unsafe for the aircraft based on stored parameters associated with the aircraft.

18. The method according to any one of claims 14 to 17, further including using periodic position data of the aircraft and position data of a runway on which the aircraft has been cleared for takeoff to provide an alert if a runway cross alert is predicted.

19. The method according to any one of claims 14 to 18, further including periodically communicating a respective position signal from each mobile unit to others of said mobile units via said wireless LAN.

20. The method according to any one of claims 14 to 19, including:
creating an automatic warning message and sending it over the Mayday emergency communication channel (36) to a pilot of a threatened aircraft and to a pilot or controller of a vehicle in risk of collision therewith;
transmitting intruder data via said wireless communications protocol to a display unit of the threatened aircraft and the display a picture of the current scene showing the aircraft's location relative to the intruder;
conveying a vocal warning to the intruder instructing him of what evasive action to take;
establishing a speech communication channel between the intruder and an air traffic controller;
showing to the air traffic controller a 3-D picture of the area at risk including background objects whose data is stored in the database; and
conveying location data to an electro-optical assembly that is moved to the desired direction and broadcasting thereby a live video of the event in real time to a control tower and to an emergency field team.

21. The method according to one of claims 14 to 20, including:
encoding each of the mobile transponders (12) with a respective access authorization code or function thereof;
upon receiving a transmission from a mobile transponder, determining from its location and access authorization code whether it is authorized to be where it is and if not taking suitable follow-up to be taken.

22. The method according to one of claims 14 to 21, including providing a satellite link in said wireless LAN for allowing increased broadcast range.

23. The method according to claim 22, including:
dividing the mobile units into subsets such that the maximal time delay within the respective mobile units in each subset does not exceed the guard interval duration of the wireless communications protocol;
estimating relative delay between subsets;
for each subset performing a different FFT each having its own time alignment; and
reducing interference in the frequency domain between subsets.

24. The method according to claim 23, including estimating overall performance and comparing with a predetermined threshold to decide whether to maintain a current setup or to adjust frequency/time portioning and or guard intervals.

25. The method according to any one of claims 14 to 24, including:
submitting a flight plan for approval by a regional control center for approval after internal design of flight path load and determining a flight path;
planning and loading a plan with respect to taxiways and runways into a site database (17); and
conveying data relating to an approved flight path to each airline dispatch center for briefing purposes.

26. The method according to claim 25, wherein on receiving “Push and Start” permission all mobile units receive an updated status and periodically performs a check routine based on a Push and Start clearance zone as determined for the type of aircraft and its location, said routine including:
receiving position data of mobile units;
checking that no unauthorized personnel or vehicles are present in a clearance zone around the aircraft by testing the position data against the clearance zone;
receiving data of other aircraft;
checking that no other object is approaching the clearance zone in accordance with a type of object associated with the mobile unit; and
checking for available clearance surrounding the aircraft using the Push and Start clearance zone parameters and providing any relevant alert to any object that is on a predicted collision course.

27. The method according to claim 26, wherein on receiving permission to taxi an aircraft unit in the permitted aircraft receives an updated status and periodically performs a check routine based on a Taxi clearance zone as determined for the type of aircraft and its location, said routine including:
checking that the aircraft is taxiing on the proper, designated runway;
using the position and velocity of the aircraft to predict its trajectory for a given period of time;
comparing said trajectory to the preloaded data of the designated runway;
periodically checking which mobile units are affected based on the planned taxiway and clearance zone; and
providing a runway cross alert if any other aircraft is predicted to taxi, land or take off in its path.

28. The method according to claim 27, including checking for and if necessary alerting other units that might approach the designated taxiway/runway from any direction that is not approved.

29. The method according to claim 27 or 28, wherein predicting the trajectory of vehicles is based on their dynamic data, type and a stored road map of the airport.

30. The method according to claim 29, including dynamically updating the road map of the airport to show temporary obstacles.

31. The method according to claim 29, including dynamically updating the road map of the airport to show permanent obstacles.

32. The method according to any one of claims 29 to 31, wherein on receiving permission for runway line up, an aircraft unit in the permitted aircraft receives an updated status and provides any relevant alert for the air crew relating to insufficient clearance surrounding the aircraft.

33. The method according to claim 32, including:
checking that landing is not in progress for the designated runway; and
checking that takeoff is not in progress for the designated runway.

34. The method according to claim 33, wherein on receiving permission for take off, an aircraft unit in the permitted aircraft receives an updated status and provides any relevant alert for the air crew as well as other mobile units relating to insufficient clearance surrounding the aircraft.

35. The method according to claim 34, including:
checking that landing is not in progress for the designated runway; and
checking that takeoff is not in progress from a different line-up location for the designated runway.

36. The method according to any one of claims 14 to 35, further including correcting for Doppler shift caused by signal transmissions between a base station and a fast moving mobile station.

37. The method according to claim 36, wherein correcting for Doppler shift includes reducing the size of the Fast Fourier Transform (FFT).

38. The method according to claim 36 or 37, wherein correcting for Doppler shift includes using a closed-loop uplink Doppler correction mechanism by:
the base station estimates the Doppler shift corresponding to each mobile station using transmitted uplink pilots and informs the mobile station (through downlink signaling) to compensate for the frequency shift;
downlink messaging is performed whenever the base station estimates a shift that is larger than a predefined threshold, and
and the corresponding compensation is performed by the mobile station in the subsequent uplink subframes.

39. The method according to claim 36 or 37, wherein correcting for Doppler shift includes separating the mobile stations' transmission in the time domain, such that each mobile station transmits in a different zone, the zones being defined on disjoint support in the time domain.

40. The method according to claim 36 or 37, wherein correcting for Doppler shift includes creation by the base station of horizontal uplink allocations and separating them by the insertion of guard-bands in order to combat a lack of orthogonality arising from the different Doppler shifts pertaining to different mobile stations.

41. A computer program comprising computer program code means for performing the method according to any of claims 14 to 40 when said program is run on a computer.

42. A computer program as claimed in claim 41 embodied on a computer readable medium.
